(19) United States
(12) Patent Application Publication
(10) Pub. No.: US 2020/0092087 A1
(43) Pub. Date: Mar. 19, 2020

(54) APPARATUS AND METHODS FOR AUTHENTICATION USING MESSAGE EXCHANGE

(71) Applicant: QUALCOMM Incorporated, San Diego, CA (US)

(72) Inventors: John HILLAN, Alton (GB); Jeremy Robin Christopher O'DONOGHUE, Wokingham (GB)

(21) Appl. No.: 16/132,309

(22) Filed: Sep. 14, 2018

(51) Int. Cl. H04L 9/08; H04L 9/32

(52) U.S. Cl. CPC H04L 9/0819; H04L 9/32; H04L 9/0866; H04L 9/085

(57) ABSTRACT

Examples herein disclose apparatus and methods for NFC authentication using NDEF message exchange. In one example, a mapping from the NFC Authentication process to suitable NDEF records and messages occurs during the bonding and authentication phases. This may include new NDEF record types plus a mapping of the relevant steps in the NFC authentication process where data is exchanged to the NDEF messages that are to be used in each step and new mechanisms by which errors can be indicated and detected by the devices.

### FIELD OF DISCLOSURE

This disclosure relates generally to near field communications, and more specifically, but not exclusively, to near field communication authentication using a near field data exchange format message exchange.

### BACKGROUND

Near-field communication (NFC) is a set of communication protocols that enable two electronic devices, to establish communication by bringing them within a short distance of each other. The NFC Forum defines standards or protocols for devices and operations in the NFC ranges. NFC-enabled portable devices can be provided with application software, for example to read electronic tags or make payments when connected to an NFC-compliant apparatus. NFC employs electromagnetic induction between two loop antennas when NFC-enabled devices—for example a smartphone and a printer—exchange information, operating within the globally available unlicensed radio frequency (industrial, scientific, and medical (ISM)) band of 13.56 MHz on International Organization for Standardization/International Electrotechnical Commission (ISO/IEC) 18000-3 air interface at rates ranging from 106 to 424 kbit/s. Each full NFC device can work in three modes: (1) NFC card emulation—Enables NFC-enabled devices such as smartphones to act like smart cards, allowing users to perform transactions such as payment or ticketing; (2) NFC reader/writer—Enables NFC-enabled devices to read information stored on inexpensive NFC tags embedded in labels or smart posters; and (3) NFC peer-to-peer—Enables two NFC-enabled devices to communicate with each other to exchange information in an ad hoc fashion.

NFC tags can be read, and under some circumstances written to, by an NFC device. They typically contain data (as of 2015 between 96 and 8,192 bytes) and may be read-only or rewritable in normal use. Applications include secure personal data storage (e.g., debit or credit card information, loyalty program data, personal identification numbers (PINs), and contacts). NFC tags can be custom-encoded by their manufacturers or use the industry specifications. The standards were provided by the NFC Forum. The NFC Forum is responsible for promoting the technology and setting standards and certifies device compliance. NFC standards cover communications protocols and data exchange formats and are based on existing radio-frequency identification (RFID) standards including ISO/IEC 14443 and ISO/IEC 18092.

There is a current activity within the NFC Forum to define a mechanism by which a reader/writer can perform authentication with a card. The work in progress defines algorithms for a bonding phase and an authentication phase. During the bonding phase, two devices can establish a shared secret associated with the bonding identifier of the other device. During the authentication phase, two devices which are bonded can derive a session key based on the associated shared secret and a pair of random numbers. The draft specification then defines a mapping from the algorithms to a set of underlying message exchanges. However, the current mapping is only to ISO/IEC 7816 Application Protocol Data Units (APDUs). There are several reasons why APDUs are not the best choice. First, the NFC Forum defines its own format for data exchange, NFC Data Exchange Format (NDEF), over which it has full control. Second, ISO/IEC 7816 APDUs only apply to Type 4 tags (those which support the ISO-DEP communication protocol), which means that others, notably Type 3 or FeliCa tags, cannot use this mechanism. Third, there is a general trend in the industry away from ISO/IEC 7816 as a transport protocol so its long term future is unclear.

Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method of exchanging messages using a Near Field Communication Data Exchange Format (NDEF) record type, comprises: generating, by a first device, an identifier request message, the identifier request message comprises a first bonding identifier; sending, by the first device, the identifier request message to a second device; generating, by the second device, an identifier response message, the identifier response message comprises a second bonding identifier different from the first bonding identifier; reading, by the first device, the identifier response message; generating, by the first device, a bonding request message, the bonding request message comprises a first encryption key; sending, by the first device, the bonding request message to the second device; generating, by the second device, a bonding response message, the bonding response message comprises a second encryption key different from the first encryption key; reading, by the first device, the bonding response message; and bonding the first device and the second device using a shared encryption key based on the first encryption key and the second encryption key.

In another aspect, a non-transitory computer-readable medium comprising instructions that when executed by a processor cause the processor to perform a method comprising: generating, by a first device, an identifier request message, the identifier request message comprises a first bonding identifier; sending, by the first device, the identifier request message to a second device; generating, by the second device, an identifier response message, the identifier response message comprises a second bonding identifier different from the first bonding identifier; reading, by the first device, the identifier response message; generating, by the first device, a bonding request message, the bonding request message comprises a first encryption key; sending, by the first device, the bonding request message to the second device; generating, by the second device, a bonding response message, the bonding response message comprises a second encryption key different from the first encryption key; reading, by the first device, the bonding response message; and bonding the first device and the second device using a shared encryption key based on the first encryption key and the second encryption key.

In still another aspect, an apparatus for exchanging messages using a Near Field Communication Data Exchange Format (NDEF) record type comprises: a memory; an antenna; a processor coupled to the memory and the antenna, wherein the processor is configured to: generate an identifier request message, the identifier request message comprises a first bonding identifier; send the identifier request message to a Near Field Communication (NFC) enabled device; read an identifier response message, the identifier response message comprises a second bonding identifier generated by the NFC enabled device that is different from the first bonding identifier; generate a bonding request message, the bonding request message comprises a first encryption key;

send the bonding request message to the NFC enabled device; read a bonding response message, the bonding response message comprises a second encryption key generated by the NFC enabled device that is different from the first encryption key; and bond the apparatus and the NFC enabled device using a shared encryption key based on the first encryption key and the second encryption key.

In still another aspect, an apparatus for exchanging messages using a Near Field Communication Data Exchange Format (NDEF) record type comprises: a memory; an antenna; a processor coupled to the memory and the antenna, wherein the processor is configured to: receive an identifier request message sent by a first device, the identifier request message comprises a first bonding identifier; send an identifier response message to the first device, the identifier response message comprises a second bonding identifier generated by the apparatus that is different from the first bonding identifier; receive a bonding request message from the first device, the bonding request message comprises a first encryption key; send a bonding response message, the bonding response message comprises a second encryption key generated by the apparatus that is different from the first encryption key; and bond the apparatus and the first device using a shared encryption key based on the first encryption key and the second encryption key.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 is an exemplary block diagram of a wireless communication system in accordance with some examples of the disclosure;

FIG. 2 is an exemplary schematic diagram of a wireless communication system in accordance with some examples of the disclosure;

FIG. 3 is an exemplary block diagram of a NFC environment in accordance with some examples of the disclosure;

FIG. 4 is an exemplary block diagram of a NDEF message in accordance with some examples of the disclosure;

FIG. 5 is an exemplary diagram of a NFC bonding process in accordance with some examples of the disclosure;

FIG. 6 is an exemplary diagram of a NFC authentication process in accordance with some examples of the disclosure;

FIG. 7 is an exemplary partial method in accordance with some examples of the disclosure;

FIG. 8 illustrates an exemplary mobile device in accordance with some examples of the disclosure; and

FIG. 9 illustrates various electronic devices that may be integrated with any of the aforementioned integrated device, semiconductor device, integrated circuit, die, interposer, package or package-on-package (PoP) in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs.

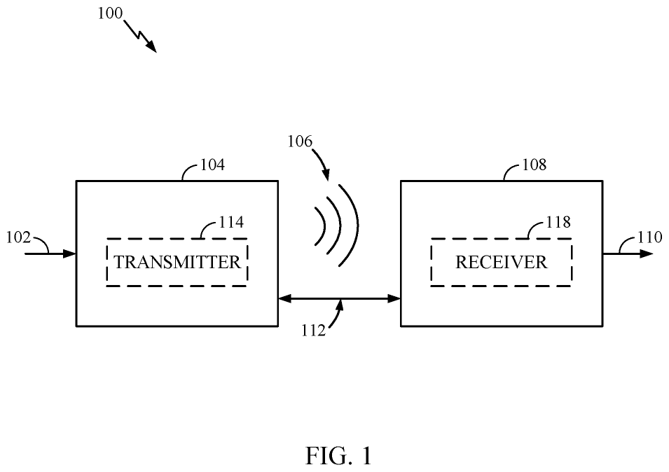

FIG. 1 is a block diagram of a wireless communication system in accordance with some examples of the disclosure. As shown in FIG. 1, a wireless communication system 100 may include an Input power 102 provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In one example, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission, and receiver 108 further includes a receive antenna 118 for providing a means for energy reception. The transmit and receive antennas 114, 118 are sized according to applications and devices to be associated therewith. As stated, an efficient energy transfer occurs by coupling a large portion of the energy in the near-field of the transmitting antenna 114 to a receiving antenna 118 rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

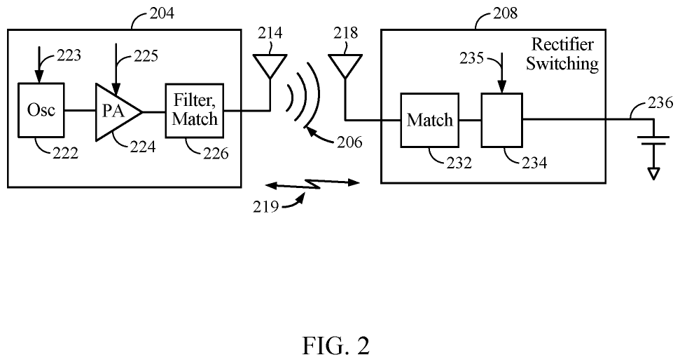

FIG. 2 is a schematic diagram of a wireless communication system in accordance with some examples of the disclosure. As shown in FIG. 2, the transmitter 204 includes an oscillator 222, a power amplifier 224 and a filter and matching circuit 226. The oscillator 222 is configured to generate a signal at a desired frequency, which may be adjusted in response to adjustment signal 223. The oscillator signal may be amplified by the power amplifier 224 with an amplification amount responsive to control signal 225. The filter and matching circuit 226 may be included to filter out harmonics or other unwanted frequencies and match the impedance of the transmitter 204 to the transmit antenna 214.

The receiver 208 may include a matching circuit 232 and a rectifier and switching circuit 234 to generate a DC power output to charge a battery 236 as shown in FIG. 2 or power a device coupled to the receiver (not shown). The matching circuit 232 may be included to match the impedance of the receiver 208 to the receive antenna 218. The receiver 208 and transmitter 204 may communicate on a separate communication channel 219 (e.g., Bluetooth, Zigbee, cellular, etc.).

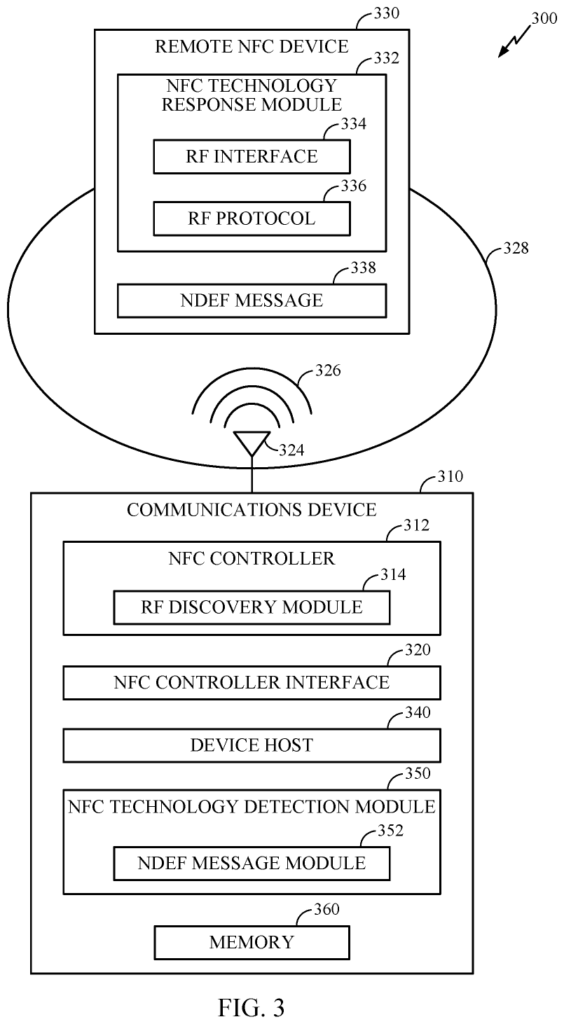

FIG. 3 is a block diagram of a NFC environment in accordance with some examples of the disclosure. As shown in FIG. 3, a block diagram of a communication network 300 according to one example is illustrated. Communication network 300 may include a communications device 310 which, through antenna 324, may be within an operating volume 328 of a remote NFC device 330. Communications device 310 may use one or more NFC RF technologies 326 (e.g., NFC-A, NFC-B, NFC-F, etc.). In an aspect, communications device 310 may use NFC technology detection module 350 to poll the operating volume 328 to attempt to detect the presence of and identify a remote NFC device 330. In an aspect, a remote NFC device (e.g., a tag,) may be configured to communicate a data using an NDEF message 338. The remote NFC device may communicate the NDEF message using NFC technology response module 332 through one or more RF interfaces 334 using one or more RF protocols 336. In an aspect, the remote NFC device may be configurable to use an RF technology such as NFC-A, NFC-B, NFC-F, etc. when transmitting the NDEF message along with similar technology for transmitting. In another aspect, communications device 310 may be configurable to be connected to an access network and/or core network (e.g., a CDMA network, a GPRS network, a UMTS network, and other types of wireline and wireless communication networks). In an aspect, remote NFC device 330 may include but are not limited to a tag, a remote peer target device, etc.

Communications device 310 may include NCI 320. In an aspect, NCI 320 may be configurable to enable communications between a device host (DH) 340 and a NFC controller (NFCC) 312.

Communications device 310 may include a NFC controller (NFCC) 312. In an aspect, NFCC 312 may include RF discovery module 314. RF discovery module 314 may be configurable to perform RF discovery using a discovery process. One aspect of the discovery process may include polling for the presence of a remote NFC device configurable to communicate using an RF technology such as NFC-A, NFC-B, NFC-F, etc. DH 340 may be configurable to generate a command to prompt NFCC 312 to perform various functions associated with RF discovery.

Communications device 310 may include NFC technology detection module 350. NFC technology detection module 350 may be configurable to detect the presence of and/or receive data from a remote NFC device 330 within the operating volume 328. In an aspect, the remote NFC device 330 may send a NDEF message. NFC technology detection module 350 may further include NDEF message module 352 that may be configured to analyze the received NDEF message 338. In an aspect, NDEF message module 352 may infer contextual information from various sources to assist with processing received data. In an aspect, the contextual information may be associated with remote NFC device 330, the received data, and/or the NDEF message 338. In another aspect, the NDEF message module 352 may obtain contextual information from one or more sensors associated with the communications device 310. Such contextual information may include, but is not limited to, location information associated with the communications device 310, time of day information, day of a week information, date information, NFC technology type used to obtain the data, a bit rate of the data, an amount of data available from the remote NFC device 330, a prior communication with the remote NFC device 330, analysis of an order of communications (e.g., which device modulated an RF field first) between the remote NFC device 330 and the communications device 310, analysis of a portion of the data, etc. In another aspect, where an application provides a data to be transmitted to a remote NFC device 330 in a complete NDEF message format, NDEF message module may determine, at least in part based on the obtained contextual information, that the remote NFC device 330 is configured to receive an NDEF message 338. Although FIG. 3 depicts NFC technology detection module 350 as a separate module, one of ordinary skill in the art would appreciate that the functionality associated with NFC technology detection module 350 may be included within one or more components, such as but not limited to, NFCC 312, DH 340, etc. Communications device 310 may include further include memory 360 that may be configurable to store received data and/or a NDEF message for processing by one or more applications associated with the communications device 310.

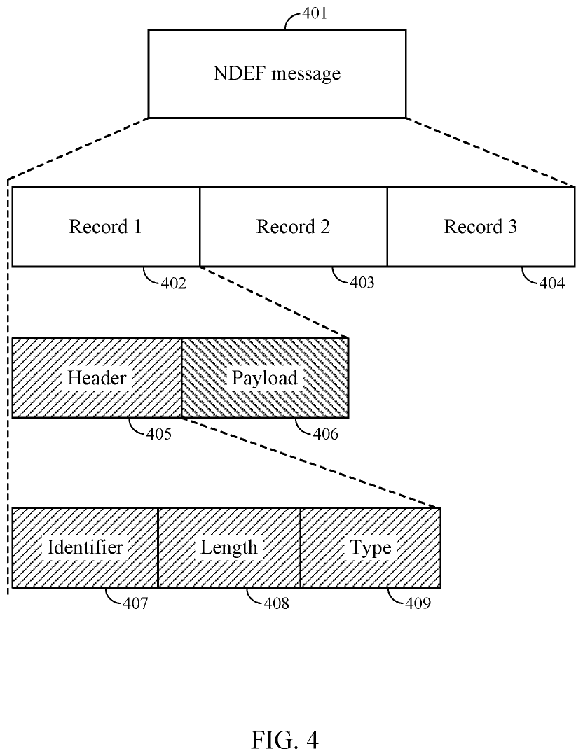

FIG. 4 is an exemplary block diagram of a NDEF message in accordance with some examples of the disclosure. As shown in FIG. 4, an NDEF message 401 (e.g., NDEF message 338) may include a first record 402, a second record 403, and a third record 404. The first record 402, for example, may include a header 405 and a payload 406. The header 405 may include an identifier 407, a length 408, and a type 409. The NDEF message 401 may be formatted in accordance with NDEF standards such as NDEF Technical Specification, NFC Forum, NDEF 1.0. NDEF messages provide a standardized method for a reader to communicate with an NFC device. The NDEF message 401 contains one or more records, as shown in FIG. 4. The NFC Forum currently defines five tag types, all of which support the same NDEF message format. The NDEF message 401 disclosed herein may include a new type of tag indicated by type 409 that enable the processes disclosed herein.

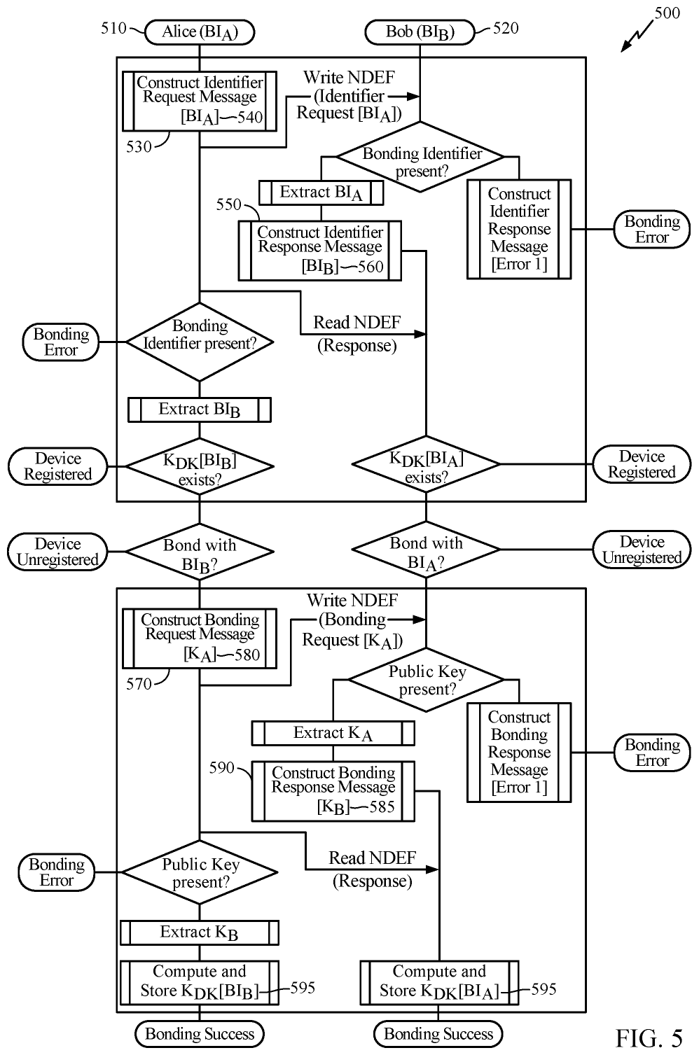

FIG. 5 is an exemplary diagram of a NFC bonding process in accordance with some examples of the disclosure. As shown in FIG. 5, a NFC bonding process 500 may include a first device 510 (e.g., an NFC enabled device) and a second device 520 (e.g., an NFC enabled device). The first device 510 may initiate the NFC bonding process 500 by generating an identifier request message 530 (e.g., NDEF message 401) that includes a first bonding identifier 540. The identifier request message 530 may be sent to the second device 520. In response, the second device 520 may then generate an identifier response message 550 (e.g., NDEF message 401) that includes a second bonding identifier 560 after extracting the first bonding identifier 540. The first device 510 may then read the identifier response message 550 and extract the second bonding identifier 560. The first device 510 may then generate a bonding request message 570 (e.g., NDEF message 401) that includes a first encryption key 580. The first device 510 may send the bonding request message 570 to the second device 520. In response, the second device 520 may extract the first encryption key 580 to generate a bonding response message 590 (e.g., NDEF message 401) that includes a second encryption key 585. The first device 510 may then read the bonding response message 590 and extract the second encryption key 585. The first device 510 may then bond with the second device 520 using a shared encryption key 595 based on the first encryption key 580 and the second encryption key 585.

The NFC bonding process 500 may use a tag or card emulation mode that uses NDEF messages, such as shown in FIG. 5. The first device 510 may act as the NFC Reader Device and the second device 520 may act as a Tag or a Card Emulator in accordance with NFC standards and protocol. The NFC bonding process 500 may use the following NDEF messages that are mapped into the credential establishment steps defined by the NFC Forum. The first device 510 may: (1) send BI_{A} (e.g., first bonding identifier 540) to the remote device by writing an identifier request message 530 with the value placed in a Bonding Identifier Record; (2) attempt to receive BI_{B} (e.g., second bonding identifier) from the remote device by reading a NFC response message, if this is not an Identifier Response Message 550 containing a Bonding Identifier Record, exit the credential agreement procedure with an indication of a bonding error. Otherwise extract BI_{B} from the Bonding Identifier Record; (3) if a K_{DK} for the value of BI_{B} is present, the devices are already bonded, exit the credential agreement procedure with an indication of success; (4) send K_{A} (e.g., a first encryption key 580) to the remote device by writing a bonding request message 570 with the value placed in a Public Key Record; and (5) attempt to receive K_{B} (e.g., a second encryption key 585) from the remote device by reading a NDEF Response Message, if this is not a bonding response message 590 containing a Public Key Record, exit the credential agreement procedure with an indication of a bonding error otherwise extract K_{B} from the Public Key Record.

The second device 520 may: (1) receive BI_{A} from the remote device by parsing a written NFC request message, if this is not a identifier request message 530 containing a Bonding Identifier Record, indicate a bonding failure by preparing a readable identifier response message 550 with the value 0x01 placed in an Error Record, and exit the credential agreement procedure with an indication of a bonding error otherwise extract BI_{A} from the Bonding Identifier Record; (2) send BI_{B} (e.g., second bonding identifier 560) to the remote device by preparing a readable identifier response message 550 with the value placed in a Bonding Identifier Record; (3) if K_{DK} for the value of BI_{A} is present, the devices are already bonded, exit the credential agreement procedure with an indication of success; (4) receive K_{A} from the remote device by parsing a written NDEF Request Message, if this is not a bonding request message 570 containing a Public Key Record, indicate a bonding failure by preparing a readable bonding response message 590 with the value 0x02 placed in an Error Record, and exit the credential agreement procedure with an indication of a bonding error otherwise extract K_{A} from the Public Key Record, and send K_{B} to the remote device by preparing a readable bonding response message 590 with the value placed in a Public Key Record.

It should be understood that the above is but one sequence of a bonding process using NDEF Message exchange to transport data items that may be needed during a bonding process in a sequence defined by the NFC Forum now and in the future.

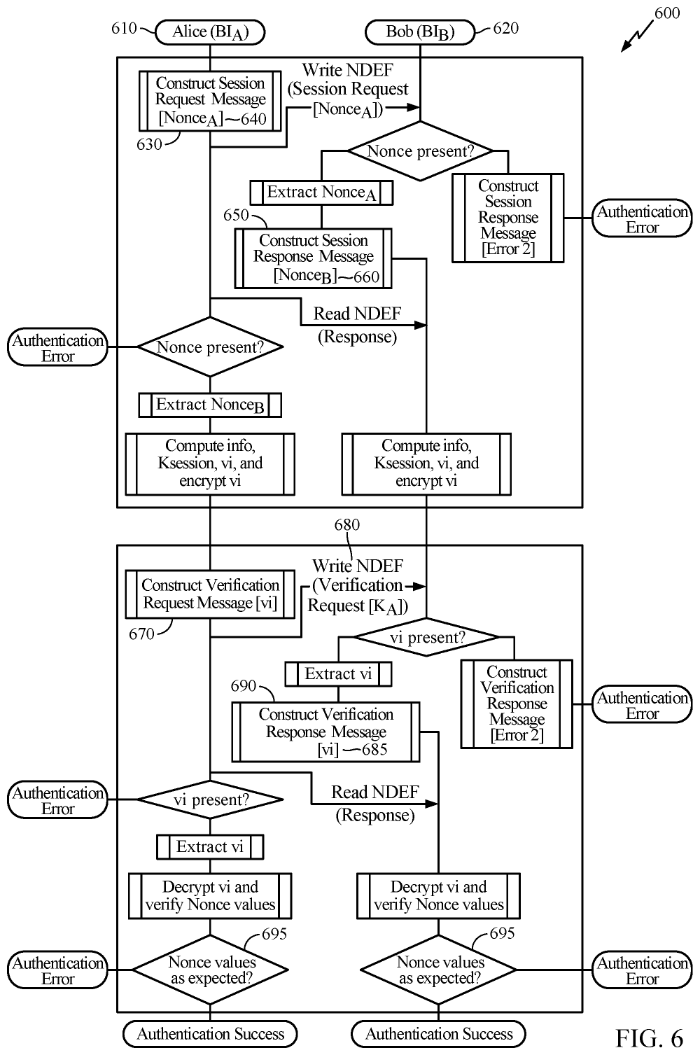

FIG. 6 is an exemplary diagram of a NFC authentication process in accordance with some examples of the disclosure. As shown in FIG. 6, a NFC authentication process 600 may include a first device 610 (e.g., an NFC enabled device) and a second device 620 (e.g., an NFC enabled device). The first device 610 may initiate the NFC authentication process 600 by generating a session request message 630 (e.g., NDEF message 401) that includes a first nonce 640. The session request message 630 may be sent to the second device 620. In response, the second device 620 may then generate a session response message 650 (e.g., NDEF message 401) that includes a second nonce 660 after extracting the first nonce 640. The first device 610 may then read the session response message 650 and extract the second nonce 660. The first device 610 may then generate a verification request message 670 (e.g., NDEF message 401) that includes a first confirmation value 680. The first device 610 may send the verification request message 670 to the second device 620. In response, the second device 620 may extract the first confirmation value 680 to generate a verification response message 690 (e.g., NDEF message 401) that includes an encryption key 685. The first device 610 may then read the verification response message 690 and extract the encryption key 685. The first device 610 may then authenticate a session 695 with the second device 620 using the encryption key 685.

The NFC authentication process 600 may use a tag or card emulation mode that uses NDEF Messages, such as shown in FIG. 6. The first device 610 may act as the NFC Reader Device and the second device 620 may act as a Tag or Card Emulator in accordance with NFC standards and protocol. The NFC authentication process 600 may use the following NDEF messages that are mapped into the authentication steps defined by the NFC forum. The first device 610 may: (1) send Nonce_{A} (e.g., first nonce 640) to the remote device by writing a session request message 630 with the value placed in a Random Nonce Record; (2) attempt to receive Nonce_{B} (e.g., second nonce 660) from the remote device by reading an NDEF Response Message, if this is not a session response message 650 containing a Random Nonce Record, destroy K_{DK} for the value of BI_{B}, and exit the authentication procedure with an indication of an authentication error otherwise extract Nonce_{B} from the Random Nonce Record; (3) generate vi=0x03∥Nonce_{A}∥Nonce_{B} and encrypt vi (for example, using AES_CCM [SP800 38C]) and send the encrypted vi to the remote device by writing a verification request message 670 with the value (e.g., first confirmation value 680) placed in a Key Confirmation Record; (4) attempt to receive the encrypted vi from the remote device by reading an NDEF Response Message, if this is not a verification response message 690 containing a Key Confirmation Response Record, destroy K_{DK} for the value of BI_{B}, and terminate the authentication procedure with an indication of an authentication error otherwise extract the encrypted vi from the Key Confirmation Record, decrypt it, and verify the value Nonce_{B}∥Nonce_{A} and, if the value is not as expected, drop the connection.

The second device 620 may: (1) receive Nonce_{A} from the remote device by parsing a written NDEF Request Message, if this is not a session request message 630 containing a Random Nonce Record, destroy K_{DK} for the value of BI_{A}, indicate a bonding failure by preparing a readable verification response message 690 with the value 0x03 placed in an Error Record, and terminate the authentication procedure with an indication of an authentication error otherwise extract Nonce_{A} from the Random Nonce Record; (2) send Nonce_{B} to the remote device by preparing a readable session response message 650 with the value (e.g., second nonce 660) placed in a Random Nonce Record; (3) receive an encrypted vi (e.g., first confirmation value 680) from the remote device by parsing a written NDEF Request Message, if this is not a verification request message 670 containing a Key Confirmation Record, destroy K_{DK} for the value of BI_{B}, indicate a bonding failure by preparing a readable verification response message 690 with the value 0x04 placed in an Error Record, and terminate the authentication procedure with an indication of an authentication error otherwise extract vi=0x03∥Nonce_{A}∥Nonce_{B} from the Key Confirmation Record, decrypt it, and verify the value Nonce_{A}∥Nonce_{B}; (4) if the value is not as expected, then indicate the failure by preparing a readable verification response message 690 with the value 0x05 placed in an Error Record, and terminate the authentication procedure with an indication of an authentication error; (5) generate vi=0x05∥Nonce_{B}∥Nonce_{A} and encrypt vi (for example using AES_CCM [SP800 38C]) and send the encrypted vi to the remote device by preparing a readable verification response message 690 with the value placed in a Key Confirmation Record.

It should be understood that the above example may be modified without departing from the scope of the disclosure relating to using NDEF Message exchange for authentication. For example, while the description of generating vi=0x03∥Nonce_{A}∥Nonce_{B} and encrypt vi (for example, using AES_CCM [SP800 38C]) is used above, it should be understood that other concatenations may be used as desired or dictated by the NFC Forum. It should be understood that the above is but one sequence of an authentication process using NDEF Message exchange to transport data items that may be needed during an authentication process in a sequence defined by the NFC Forum now and in the future.

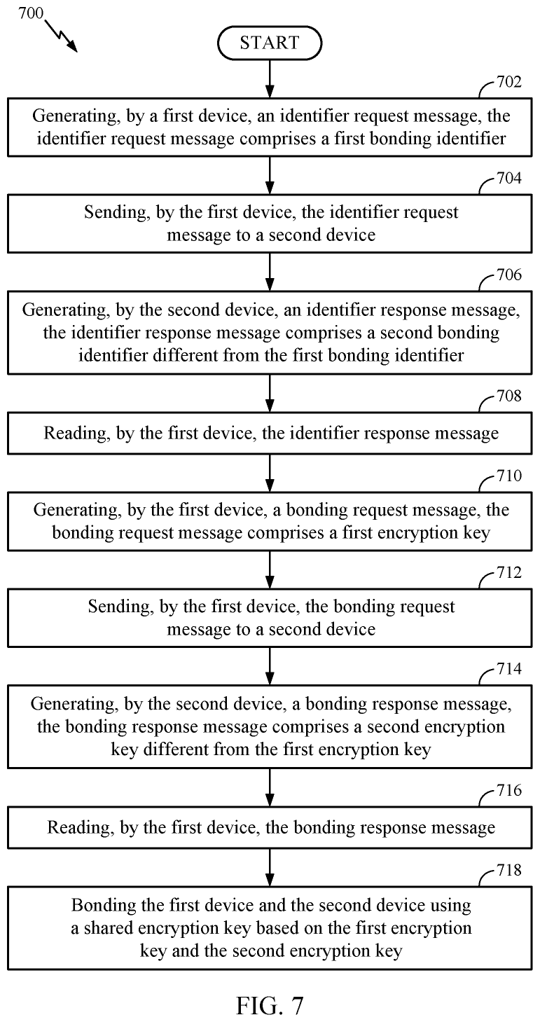

FIG. 7 is an exemplary partial method in accordance with some examples of the disclosure. As shown in FIG. 7, a partial method 700 begins in block 702 with generating, by a first device, an identifier request message, the identifier request message comprises a first bonding identifier. The partial method 700 continues in block 704 with sending, by the first device, the identifier request message to a second device. The partial method 700 continues in block 706 with generating, by the second device, an identifier response message, the identifier response message comprises a second bonding identifier different from the first bonding identifier. The partial method 700 continues in block 708 with reading, by the first device, the identifier response message. The partial method 700 continues in block 710 with generating, by the first device, a bonding request message, the bonding request message comprises a first encryption key. The partial method 700 continues in block 712 with sending, by the first device, the bonding request message to a second device. The partial method 700 continues in block 714 with generating, by the second device, a bonding response message, the bonding response message comprises a second encryption key different from the first encryption key. The partial method 700 continues in block 716 with reading, by the first device, the bonding response message. The partial method 700 may conclude in block 718 with bonding the first device and the second device using a shared encryption key based on the first encryption key and the second encryption key.

Alternatively, the partial method 700 may continue with generating, by the first device, a session request message, the session request message comprises a first nonce. The partial method 700 may continue with sending, by the first device, the session request message to the second device. The partial method 700 may continue with generating, by the second device, a session response message, the session response message comprises a second nonce different from the first nonce. The partial method 700 may continue with reading, by the first device, the session response message. The partial method 700 may continue with generating, by the first device, a verification request message, the verification request message comprises a first confirmation value. The partial method 700 may continue with sending, by the first device, the verification request message to the second device. The partial method 700 may continue with generating, by the second device, a verification response message, the verification response message comprises an encryption key. The partial method 700 may continue with reading, by the first device, the verification response message. The partial method 700 may conclude with authenticating a session between the first device and the second device based on the encryption key.

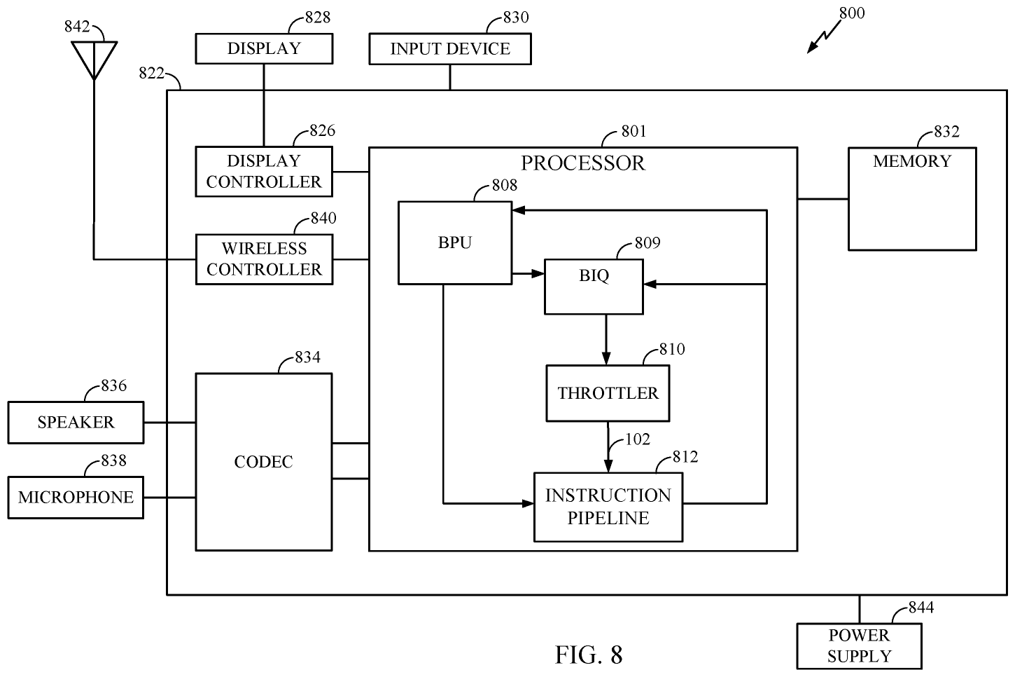

FIG. 8 illustrates an exemplary mobile device in accordance with some examples of the disclosure. Referring now to FIG. 8, a block diagram of a mobile device that is configured according to exemplary aspects is depicted and generally designated 800. In some aspects, mobile device 800 may be configured as a wireless communication device. As shown, mobile device 800 includes processor 801, which may be configured to implement the methods described herein in some aspects. Processor 801 is shown to comprise instruction pipeline 812, buffer processing unit (BPU) 808, branch instruction queue (BIQ) 809, and throttler 810 as is well known in the art. Other well-known details (e.g., counters, entries, confidence fields, weighted sum, comparator, etc.) of these blocks have been omitted from this view of processor 801 for the sake of clarity.

Processor 801 may be communicatively coupled to memory 832 over a link, which may be a die-to-die or chip-to-chip link. Mobile device 800 also include display 828 and display controller 826, with display controller 826 coupled to processor 801 and to display 828.

In some aspects, FIG. 8 may include coder/decoder (CODEC) 834 (e.g., an audio and/or voice CODEC) coupled to processor 801; speaker 836 and microphone 838 coupled to CODEC 834; and wireless controller 840 (which may include a modem) coupled to wireless antenna 842 and to processor 801.

In a particular aspect, where one or more of the above-mentioned blocks are present, processor 801, display controller 826, memory 832, CODEC 834, and wireless controller 840 can be included in a system-in-package or system-on-chip device 822. Input device 830 (e.g., physical or virtual keyboard), power supply 844 (e.g., battery), display 828, input device 830, speaker 836, microphone 838, wireless antenna 842, and power supply 844 may be external to system-on-chip device 822 and may be coupled to a component of system-on-chip device 822, such as an interface or a controller.

It should be noted that although FIG. 8 depicts a mobile device, processor 801 and memory 832 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

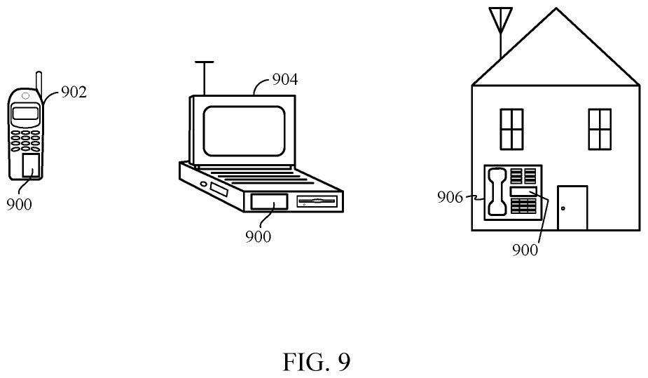

FIG. 9 illustrates various electronic devices that may be integrated with any of the aforementioned integrated device, semiconductor device, integrated circuit, die, interposer, package or package-on-package (PoP) in accordance with some examples of the disclosure. For example, a mobile phone device 902, a laptop computer device 904, and a fixed location terminal device 906 may include an integrated device 900 as described herein. The integrated device 900 may be, for example, any of the integrated circuits, dies, integrated devices, integrated device packages, integrated circuit devices, device packages, integrated circuit (IC) packages, package-on-package devices described herein. The devices 902, 904, 906 illustrated in FIG. 9 are merely exemplary. Other electronic devices may also feature the integrated device 900 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

One or more of the components, processes, features, and/or functions illustrated in FIGS. 1-9 may be rearranged and/or combined into a single component, process, feature or function or incorporated in several components, processes, or functions. Additional elements, components, processes, and/or functions may also be added without departing from the disclosure. It should also be noted that FIGS. 1-9 and its corresponding description in the present disclosure may use the following terms and processes:

Authentication NDEF Messages

An authentication message is a sequence of one or more NDEF records, where the first record is:
An Authentication Identifier Request Record (“Aireq”); or
An Authentication Identifier Response Record (“Airsp”); or
An Authentication Bonding Request Record (“Abreq”); or
An Authentication Bonding Response Record (“Abrsp”); or
An Authentication Session Request Record (“Asreq”); or
An Authentication Session Response Record (“Asrsp”); or
An Authentication Verification Request Record (“Avreq”); or
An Authentication Verification Response Record (“Avrsp”); or

The payload of the first NDEF record consists of an embedded NDEF message containing one or more NDEF records as defined in this specification.

NDEF Message Exchange Protocol

Authentication messages are sent to, or retrieved from, an NFC Tag Device by an NFC Universal Device or an NFC Reader Device. Authentication messages may be sent and retrieved using the NDEF read and NDEF write procedures defined by the NFC Forum Tag Technical Specifications [T1T], [T2T], [T3T], [T4T], [T5T].

Message Definitions

Authentication Identifier Request Message

An Authentication Requestor uses an Authentication Identifier Request Message to send its Bonding Identifier to the Authentication Responder. The first record may be an Authentication Identifier Request Record.

The Authentication Identifier Request Message may not be sent by the Authentication Responder.

Authentication Identifier Response Message

An Authentication Responder uses an Authentication Identifier Response Message to send its Bonding Identifier to the Authentication Requestor. The first record may be an Authentication Identifier Response Record.

The Authentication Identifier Response Message may not be sent by the Authentication Requestor.

Authentication Bonding Request Message

An Authentication Requestor uses an Authentication Bonding Request Message to send its bonding parameters to the Authentication Responder. The first record may be an Authentication Bonding Request Record.

The Authentication Bonding Request Message may not be sent by the Authentication Responder.

Authentication Bonding Response Message

An Authentication Responder uses an Authentication Bonding Response Message to send its bonding parameters to the Authentication Requestor. The first record may be an Authentication Bonding Response Record.

The Authentication Bonding Response Message may not be sent by the Authentication Requestor.

Authentication Session Request Message

An Authentication Requestor uses an Authentication Session Request Message to send its session parameters to the Authentication Responder. The first record may be an Authentication Session Request Record.

The Authentication Session Request Message may not be sent by the Authentication Responder.

Authentication Session Response Message

An Authentication Responder uses an Authentication Session Response Message to send its session parameters to the Authentication Requestor. The first record may be an Authentication Session Response Record.

The Authentication Session Response Message may not be sent by the Authentication Requestor.

Authentication Verification Request Message

An Authentication Requestor uses an Authentication Verification Request Message to send its encrypted confirmation code to the Authentication Responder. The first record may be an Authentication Verification Request Record.

The Authentication Verification Request Message may not be sent by the Authentication Responder.

Authentication Verification Response Message

An Authentication Responder uses an Authentication Verification Response Message to send its encrypted confirmation code to the Authentication Requestor. The first record may be an Authentication Verification Response Record.

The Authentication Verification Response Message may not be sent by the Authentication Requestor.

Global Record Definitions

Authentication Identifier Request Record

The Authentication Identifier Request Record contains the parameters of the Authentication Requestor that are necessary for the Authentication Responder to determine whether the devices are already bonded. Only the Bonding Identifier Record has a defined meaning in the NDEF payload of an Authentication Identifier Request Record. However, an implementation may silently ignore and may not raise an error if it encounters other records.

The [NDEF], [RTD] for the Authentication Identifier Request Record may be “Aireq” (in NFC binary encoding: 0x41 0x69 0x72 0x65 0x71).

The payload of a Bonding Request Record may consist of:
a version number field, followed by
a single Bonding Identifier Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

BONDING_IDENTIFIER_RECORD: A Bonding Identifier Record contains a single Bonding Identifier that is used to identify the device sending the Message which contains it.

Authentication Identifier Response Record

The Authentication Identifier Response Record normally contains the parameters of the Authentication Responder that are necessary for the Authentication Requestor to determine whether the devices are already bonded. Only the Bonding Identifier Record has a defined meaning in the NDEF payload of an Authentication Identifier Response Record. However, an implementation may silently ignore and may not raise an error if it encounters other records.

The [NDEF], [RTD] for the Authentication Identifier Response Record may be “Airsp” (in NFC binary encoding: 0x41 0x69 0x72 0x73 0x70).

The payload of an Authentication Identifier Response Record may be an embedded NDEF message, which may be composed of the following records:
a version number field, followed by
a single Bonding Identifier Record; or
a single Error Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

BONDING_IDENTIFIER_RECORD: A Bonding Identifier Record contains a single Bonding Identifier that is used to identify the device sending the Message which contains it.

ERROR_RECORD: An Error Record contains a single error reason code that is used to indicate a problem detected by the NFC Authentication Responder.

Authentication Bonding Request Record

The Authentication Bonding Request Record contains the parameters of the Authentication Requestor that are necessary for the Authentication Responder to perform bonding. Only the Public Key Record has a defined meaning in the NDEF payload of an Authentication Bonding Request Record. However, an implementation may silently ignore and may not raise an error if it encounters other records.

The [NDEF], [RTD] for the Authentication Bonding Request Record may be “Abreq” (in NFC binary encoding: 0x41 0x62 0x72 0x65 0x71).

The payload of an Authentication Bonding Request Record may be an embedded NDEF message, which may be composed of the following records:
a version number field, followed by
a single Public Key Record

Authentication Bonding Response Record

The Authentication Bonding Response Record normally contains the parameters of the Authentication Responder that are necessary for the Authentication Requestor to perform bonding, but it can also contain information about an error which has occurred during bonding. Only Public Key and Error Records have a defined meaning in the NDEF payload of an Authentication Bonding Response Record. However, an implementation may silently ignore and may not raise an error if it encounters other records.

The [NDEF], [RTD] for the Authentication Bonding Response Record may be “ABrsp” (in NFC binary encoding: 0x41 0x62 0x72 0x73 0x70).

The payload of an Authentication Bonding Response Record may be an embedded NDEF message, which may be composed of the following records:
a version number field, followed by
a single Public Key Record; or
a single Error Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

PUBLIC_KEY_RECORD: A Public Key Record contains a single Public Key that is generated by the device sending the Message which contains it.

ERROR_RECORD: An Error Record contains a single error reason code that is used to indicate a problem detected by the NFC Authentication Responder.

Authentication Session Request Record

The Authentication Session Request Record contains the parameters of the Authentication Requestor that are necessary for the Authentication Responder to compute the session key. Only the Random Nonce Record had a defined meaning in the NDEF payload of an Authentication Session Request Record. However, an implementation may silently ignore and may not raise an error if it encounters other records.

The [NDEF], [RTD] for the Authentication Session Request Record may be “Asreq” (in NFC binary encoding: 0x41 0x73 0x72 0x65 0x71).

The payload of an Authentication Session Request Record may be an embedded NDEF message, which may be composed of the following records:
a version number field, followed by
a single Random Nonce Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

RANDOM_NONCE_RECORD: A Random Nonce Record contains a single Random Nonce that is generated by the device sending the Message which contains it.

Authentication Session Response Record

The Authentication Session Response Record normally contains the parameters of the Authentication Responder that are necessary for the Authentication Requestor to compute the session key, but it can also contain information about an error which has occurred during authentication. Only Random Nonce and Error Records have a defined meaning in the NDEF payload of an Authentication Session Response Record. However, an implementation may silently ignore and may not raise an error if it encounters other records.

The [NDEF], [RTD] for the Authentication Session Response Record may be “Asrsp” (in NFC binary encoding: 0x41 0x73 0x72 0x73 0x70).

The payload of an Authentication Session Response Record may be an embedded NDEF message, which may be composed of the following records:
a version number field, followed by
a single Random Nonce Record; or
a single Error Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

RANDOM_NONCE_RECORD: A Random Nonce Record contains a single Random Nonce that is generated by the device sending the Message which contains it.

ERROR_RECORD: An Error Record contains a single error reason code that is used to indicate a problem detected by the NFC Authentication Responder.

Authentication Verification Request Record

The Authentication Verification Request Record contains the encrypted confirmation code computed by the Authentication Requestor. Only Key Confirmation Records have a defined meaning in the NDEF payload of an Authentication Verification Request Record. However, an implementation may silently ignore and may not raise an error if it encounters other records.

The [NDEF], [RTD] for the Authentication Verification Request Record may be “Avreq” (in NFC binary encoding: 0x41 0x76 0x72 0x65 0x71).

The payload of an Authentication Verification Request Record may be an embedded NDEF message, which may be composed of the following records:
a version number field, followed by
a single Key Confirmation Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

KEY_CONFIRMATION_RECORD: A Key Confirmation Record contains a single confirmation code that is generated by the device sending the Message which contains it.

Authentication Verification Response Record

The Authentication Verification Response Record normally contains the encrypted confirmation code computed by the Authentication Responder, but it can also contain information about an error which has occurred during authentication. Only Key Confirmation and Error Records have a defined meaning in the NDEF payload of an Authentication Verification Response Record. However, an implementation may silently ignore and may not raise an error if it encounters other records.

The [NDEF], [RTD] for the Authentication Verification Response Record may be “Avrsp” (in NFC binary encoding: 0x41 0x76 0x72 0x73 0x70).

The payload of an Authentication Verification Response Record may be an embedded NDEF message, which may be composed of the following records:
a version number field, followed by
a single Key Confirmation Record; or
a single Error Record

MAJOR_VERSION: This 4-bit field equals the major version number of the NFC Authentication specification and may be set to 1 by an implementation that conforms to this specification. When an NDEF Parser reads a different value, it may not assume backward compatibility.

MINOR_VERSION: This 4-bit field equals the minor version number of the NFC Authentication specification and may be set to 0 by an implementation that conforms to this specification. When an NDEF Parser reads a different value, it MAY assume backward compatibility.

KEY_CONFIRMATION_RECORD: A Key Confirmation Record contains a single confirmation code that is generated by the device sending the Message which contains it.

ERROR_RECORD: An Error Record contains a single error reason code that is used to indicate a problem detected by the NFC Authentication Responder.

Local Record Definitions

Bonding Identifier Record

The Bonding Identifier Record is used within authentication NDEF records to describe a single Bonding Identifier. It may not be used elsewhere.

The [NDEF], [RTD] for the Bonding Identifier Record may be “bi” (in NFC binary encoding: 0x62 0x69).

The payload of a Bonding Identifier Record may be composed of the following fields:
a single octet defining the length of the Bonding Identifier
a sequence of octets comprising the Bonding Identifier, with the MSB first

BONDING_IDENTIFIER_LENGTH: This field is an 8 bit integer field that defines the number of bytes following in BONDING_IDENTIFIER_CHAR.

BONDING_IDENTIFIER_CHAR: This field is a series of bytes which represents a Bonding Identifier, with the most significant byte first.

Public Key Record

The Public Key Record is used within authentication NDEF records to describe a single Public Key. It may not be used elsewhere.

The [NDEF], [RTD] for the Public Key Record may be “pk” (in NFC binary encoding: 0x70 0x6b).

The payload of a Public Key Record may be composed of the following fields:
a single octet defining the length of the Public Key
a sequence of octets comprising the Public Key, with the MSB first

PUBLIC_KEY_LENGTH: This field is an 8 bit integer field that defines the number of bytes following in PUBLIC_KEY_CHAR.

PUBLIC_KEY_CHAR: This field is a series of bytes which represents a Public Key, with the most significant byte first.

Random Nonce Record

The Random Nonce Record is used within authentication NDEF records to describe a single Random Nonce. It may not be used elsewhere.

The [NDEF], [RTD] for the Random Nonce Record may be “rn” (in NFC binary encoding: 0x72 0x6e).

The payload of a Random Nonce Record may be composed of the following fields:
a single octet defining the length of the Random Nonce
a sequence of octets comprising the Random Nonce, with the MSB first

RANDOM_NONCE_LENGTH: This field is an 8 bit integer field that defines the number of bytes following in RANDOM_NONCE_CHAR.

RANDOM_NONCE_CHAR: This field is a series of bytes which represents a Random Nonce, with the most significant byte first.

Key Confirmation Record

The Key Confirmation Record is used within authentication NDEF records to describe a single encrypted confirmation code. It may not be used elsewhere.

The [NDEF], [RTD] for the Key Confirmation Record may be “kc” (in NFC binary encoding: 0x6b 0x63).

The payload of a Key Confirmation Record may be composed of the following fields:
a single octet defining the length of the encrypted confirmation code
a sequence of octets comprising the encrypted confirmation code, with the MSB first

CONFIRMATION_CODE_LENGTH: This field is an 8 bit integer field that defines the number of bytes following in CONFIRMATION_CODE_CHAR.

CONFIRMATION_CODE_CHAR: This field is a series of bytes which represents a confirmation code, with the most significant byte first.

Error Record

The Error Record is used within authentication NDEF records to describe an error that has occurred. It may not be used elsewhere.

The [NDEF], [RTD] for the Error Record may be “err” (in NFC binary encoding: 0x65 0x72 0x72).

The payload of an Error may be composed of the following fields:
a single octet containing a reason value

ERROR_REASON: This field is an 8 bit integer field that contains a value as defined in the following table.

Error Reason Value Definitions

| Value | Description |
|---|---|
| 0 × 00 | Reserved |
| 0 × 01 | Bonding Identifier Error |
| 0 × 02 | Public Key Error |
| 0 × 03 | Random Nonce Error |
| 0 × 04 | Key Confirmation Error |
| 0 × 05 − 0 × FF | RFU |

In this description, certain terminology is used to describe certain features. The term “mobile device” can describe, and is not limited to, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). Further, the terms “user equipment” (UE), “mobile terminal,” “mobile device,” and “wireless device,” can be interchangeable.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be incorporated entirely within any form of computer readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method of exchanging messages using a Near Field Communication Data Exchange Format (NDEF) record type, comprising:
generating, by a first device, an identifier request message, the identifier request message comprises a first bonding identifier;
sending, by the first device, the identifier request message to a second device;
generating, by the second device, an identifier response message, the identifier response message comprises a second bonding identifier different from the first bonding identifier;
reading, by the first device, the identifier response message;
generating, by the first device, a bonding request message, the bonding request message comprises a first encryption key;
sending, by the first device, the bonding request message to the second device;
generating, by the second device, a bonding response message, the bonding response message comprises a second encryption key different from the first encryption key;
reading, by the first device, the bonding response message; and
bonding the first device and the second device using a shared encryption key based on the first encryption key and the second encryption key.

2. The method of claim 1, wherein the first device is configured as a near field communication (NFC) reader device and the second device is configured as a NFC tag or card emulator.

3. The method of claim 1, wherein the first bonding identifier is a bonding identifier of the first device and the second bonding identifier is a bonding identifier of the second device.

4. The method of claim 1, further comprising generating, by the first device, a session request message, the session request message comprises a first nonce;
sending, by the first device, the session request message to the second device;
generating, by the second device, a session response message, the session response message comprises a second nonce different from the first nonce; and
reading, by the first device, the session response message.

5. The method of claim 4, wherein the first device is configured as a near field communication (NFC) reader device and the second device is configured as a NFC tag or card emulator

6. The method of claim 5, further comprising
generating, by the first device, a verification request message, the verification request message comprises a first confirmation value;
sending, by the first device, the verification request message to the second device;
generating, by the second device, a verification response message, the verification response message comprises an encryption key;
reading, by the first device, the verification response message; and
authenticating a session between the first device and the second device based on the encryption key.

7. The method of claim 6, wherein the first device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

8. A non-transitory computer-readable medium comprising instructions that when executed by a processor cause the processor to perform a method comprising:
generating, by a first device, an identifier request message, the identifier request message comprises a first bonding identifier;
sending, by the first device, the identifier request message to a second device;
generating, by the second device, an identifier response message, the identifier response message comprises a second bonding identifier different from the first bonding identifier;
reading, by the first device, the identifier response message;
generating, by the first device, a bonding request message, the bonding request message comprises a first encryption key;
sending, by the first device, the bonding request message to the second device;
generating, by the second device, a bonding response message, the bonding response message comprises a second encryption key different from the first encryption key;
reading, by the first device, the bonding response message; and
bonding the first device and the second device using a shared encryption key based on the first encryption key and the second encryption key.

9. The non-transitory computer-readable medium of claim 8, wherein the first device is configured as a near field communication (NFC) reader device and the second device is configured as a NFC tag or card emulator.

10. The non-transitory computer-readable medium of claim 8, wherein the first bonding identifier is a bonding identifier of the first device and the second bonding identifier is a bonding identifier of the second device.

11. The non-transitory computer-readable medium of claim 8, wherein the method further comprises:
generating, by the first device, a session request message, the session request message comprises a first nonce;
sending, by the first device, the session request message to the second device;
generating, by the second device, a session response message, the session response message comprises a second nonce different from the first nonce; and
reading, by the first device, the session response message.

12. The non-transitory computer-readable medium of claim 11, wherein the first device is configured as a near field communication (NFC) reader device and the second device is configured as a NFC tag or card emulator.

13. The non-transitory computer-readable medium of claim 12, wherein the method further comprises:
generating, by the first device, a verification request message, the verification request message comprises a first confirmation value;
sending, by the first device, the verification request message to the second device;
generating, by the second device, a verification response message, the verification response message comprises an encryption key;
reading, by the first device, the verification response message; and
authenticating a session between the first device and the second device based on the encryption key.

14. The non-transitory computer-readable medium of claim 8, wherein the first device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

15. An apparatus for exchanging messages using a Near Field Communication Data Exchange Format (NDEF) record type, comprising:
a memory;
an antenna;
a processor coupled to the memory and the antenna, wherein the processor is configured to:
generate an identifier request message, the identifier request message comprises a first bonding identifier;
send the identifier request message to a Near Field Communication (NFC) enabled device;
read an identifier response message, the identifier response message comprises a second bonding identifier generated by the NFC enabled device that is different from the first bonding identifier;
generate a bonding request message, the bonding request message comprises a first encryption key;
send the bonding request message to the NFC enabled device;
read a bonding response message, the bonding response message comprises a second encryption key generated by the NFC enabled device that is different from the first encryption key; and
bond the apparatus and the NFC enabled device using a shared encryption key based on the first encryption key and the second encryption key.

16. The apparatus of claim 15, wherein the apparatus is configured as a near field communication (NFC) reader device and the NFC enabled device is configured as a NFC tag or card emulator.

17. The apparatus of claim 15, wherein the first bonding identifier is a bonding identifier of the apparatus and the second bonding identifier is a bonding identifier of the NFC enabled device.

18. The apparatus of claim 15, wherein the processor is further configured to:
generate a session request message, the session request message comprises a first nonce;
send the session request message to the NFC enabled device; and
read a session response message generated by the NFC enabled device, the session response message comprises a second nonce different from the first nonce.

19. The apparatus of claim 18, wherein the apparatus is configured as a near field communication (NFC) reader device and the NFC enabled device is configured as a NFC tag or card emulator.

20. The apparatus of claim 19, wherein the processor is further configured to:
generate a verification request message, the verification request message comprises a first confirmation value;
send the verification request message to the NFC enabled device;
read a verification response message generated by the NFC enabled device, the verification response message comprises an encryption key; and
authenticate a session between the apparatus and the NFC enabled device based on the encryption key.

21. The apparatus of claim 15, wherein the apparatus is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

22. An apparatus for exchanging messages using a Near Field Communication Data Exchange Format (NDEF) record type, comprising:
a memory;
an antenna;
a processor coupled to the memory and the antenna, wherein the processor is configured to:
receive an identifier request message sent by a first device, the identifier request message comprises a first bonding identifier;
send an identifier response message to the first device, the identifier response message comprises a second bonding identifier generated by the apparatus that is different from the first bonding identifier;
receive a bonding request message from the first device, the bonding request message comprises a first encryption key;
send a bonding response message, the bonding response message comprises a second encryption key generated by the apparatus that is different from the first encryption key; and
bond the apparatus and the first device using a shared encryption key based on the first encryption key and the second encryption key.

23. The apparatus of claim 22, wherein the first device is configured as a near field communication (NFC) reader device and the apparatus is configured as a NFC tag or card emulator.

24. The apparatus of claim 22, wherein the first bonding identifier is a bonding identifier of the first device and the second bonding identifier is a bonding identifier of the apparatus.

25. The apparatus of claim 22, wherein the processor is further configured to:
receive a session request message generated by the first device, the session request message comprises a first nonce; and
generate a session response message, the session response message comprises a second nonce different from the first nonce.

26. The apparatus of claim 25, wherein the first device is configured as a near field communication (NFC) reader device and the apparatus is configured as a NFC tag or card emulator.

27. The apparatus of claim 26, wherein the processor is further configured to:
receive a verification request message generated by the first device, the verification request message comprises a first confirmation value;
generate a verification response message, the verification response message comprises an encryption key; and
authenticate a session between the first device and the apparatus based on the encryption key.

28. The apparatus of claim 22, wherein the apparatus is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.
